(19) United States
(12) Patent Application Publication
(10) Pub. No.: US 2007/0133957 A1
(43) Pub. Date: Jun. 14, 2007

(54) Method of controlling speed of BLDC motor and method of controlling cooling speed of refrigerator using the same

(75) Inventors: Kwang-kyo Oh, Gwangju-city (KR); Koji Hamaoka, Gwangju-city (KR); Han-joo Yoo, Gwangju-city (KR); Pyeong-ki Park, Gwangju-city (KR); Jeong-ho Seo, Gwangju-city (KR); Hun-yub Bae, Gwangju-city (KR); Yun-Jeong Kim, Gwangju-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/634,267

(22) Filed: Dec. 6, 2006

(30) Foreign Application Priority Data
Dec. 9, 2005 (KR) 2005-0120330

(51) Int. Cl. H02P 7/288

(52) U.S. Cl. 388/833

(57) ABSTRACT

A method of controlling the speed of a BLDC (brushless direct current) motor and a method of controlling the cooling speed of a refrigerator using the same. A method of controlling the speed of a BLDC motor includes: inputting a driving signal having a predetermined reference current applying angle to the motor to achieve a predetermined reference speed; measuring a rotating speed of the motor; increasing a current applying angle of the driving signal if the measured rotating speed does not reach the reference speed and the driving signal has reached a maximum input of the motor; and inputting the driving signal having the increased current applying angle to the BLDC motor.

### CROSS-REFERENCE TO RELATED APPLICATIONS

This application claims the benefit of Korean Patent Application No. 2005-0120330, filed on Dec. 9, 2005, in the Korean Intellectual Property Office, the disclosure of which is incorporated herein by reference.

### BACKGROUND OF THE INVENTION

1. Field of the Invention

The present invention relates to a method of controlling the speed of a BLDC (brushless direct current) motor and a method of controlling the cooling speed of the refrigerator using the same, and more particularly, to a method of controlling the speed of a BLDC motor in which an output speed is increased by a driving signal having an increased current applying angle and a method of controlling the cooling speed of a refrigerator to which the method of controlling the speed of the BLDC motor is applied.

2. Description of the Related Art

A BLDC motor is designed to be operated without a brush used in a conventional DC motor, which may become damaged by repetitive friction. The BLDC motor is widely used in accordance with the development of a semiconductor device used to drive the BLDC motor.

In particular, the BLDC motor may be applied to a compressor or other part of a refrigerator to achieve a cooling temperature of the refrigerator. Generally, in designing the refrigerator, rated output power of a motor is determined on the basis of a driving speed, a load torque and other operating conditions of the refrigerator.

However, when the refrigerator is operated, if voltage from a power source is low or the load torque becomes excessively large compared with a general operating condition due to, for example, a rise in ambient temperature, an operating speed of the motor may not reach a reference speed, which causes a problem in that a cooling speed of the refrigerator is therefore reduced.

Such a problem may be solved by designing a motor having a larger regular rated output power. However, if the rated output power of the motor becomes too large relative to the general operating conditions, the effectiveness of the motor may decrease.

### SUMMARY OF THE INVENTION

Accordingly, it is an aspect of the present invention to provide a method of controlling the speed of a BLDC motor in which the range of the operating speed may be expanded.

It is another aspect of the present invention to provide a method of controlling a cooling speed of a refrigerator having the BLDC motor, so that reduction of the cooling speed of the refrigerator may be minimized.

Additional aspects and/or advantages of the present invention will be set forth in part in the description which follows and, in part, will be apparent from the description, or may be learned by practice of the present invention.

The foregoing and/or other aspects of the present invention are also achieved by providing a method of controlling the speed of a BLDC motor, the method including: inputting a driving signal having a predetermined reference current applying angle to the motor to achieve a predetermined reference speed; measuring a rotating speed of the motor; increasing a current applying angle of the driving signal if the measured rotating speed does not reach the reference speed and the driving signal has reached a maximum input of the motor; and inputting the driving signal having the increased current applying angle to the BLDC motor.

According to another aspect of the present invention, the current applying angle of the driving signal is increased by a predetermined angular increment until the rotating speed reaches the reference speed.

According to another aspect of the present invention, the motor includes a three-phase brushless motor.

According to another aspect of the present invention, the reference current applying angle is approximately 120° and the increased current applying angle of the driving signal does not exceed approximately 150°.

According to another aspect of the present invention, the method of controlling the speed of a BLDC motor further includes gradually decreasing the increased current applying angle of the driving signal until the rotating speed of the motor reaches the reference speed if the rotating speed of the motor exceeds the reference speed because of the increased current applying angle of the driving signal.

The foregoing and/or other aspects of the present invention are also achieved by providing a method of controlling a cooling speed of a refrigerator which comprises a compressor having a BLDC motor, the method including: inputting a driving signal having a predetermined reference current applying angle to the motor to achieve a predetermined reference temperature; measuring a cooling temperature of the refrigerator; gradually increasing a current applying angle of the driving signal by a predetermined angular increment until the cooling temperature reaches the reference temperature if the measured cooling temperature does not reach the reference temperature and the driving signal has reached a maximum input of the motor; and inputting the driving signal having the increased current applying angle to the BLDC motor.

### BRIEF DESCRIPTION OF THE DRAWINGS

The above and/or other aspects and advantages of the present invention will become apparent and more readily appreciated from the following description of the embodiment, taken in conjunction with the accompanying drawings of which:

FIG. 1 is a block diagram of a control system to which a method of controlling the speed of a BLDC motor according to an embodiment of the present invention is applied.

FIG. 2A is a schematic diagram of electrode coils of the BLDC motor according to the embodiment of the present invention.

FIG. 2B is a graph illustrating waveforms of induced voltages generated when the control system of FIG. 1 is operated according to the embodiment of the present invention.

FIG. 2C is a graph illustrating the driving signals generated when the control system of FIG. 1 is operated according to the embodiment of the present invention.

FIG. 3 is a graph illustrating a speed increase effect when the method of controlling the speed of a BLDC motor according to the embodiment of the present invention is applied.

FIG. 4 is a table showing a measurement result of the capability of a BLDC motor to which the embodiment of the present invention is applied.

FIG. 5 is a flow diagram to illustrate a method of controlling the speed of a BLDC motor according to the embodiment of the present invention.

### DETAILED DESCRIPTION OF THE PREFERRED EMBODIMENT

Reference will now be made in detail to the embodiment of the present invention, examples of which are illustrated in the accompanying drawings, wherein like reference numerals refer to like elements throughout. The embodiment is described below to explain the present invention by referring to the Figures.

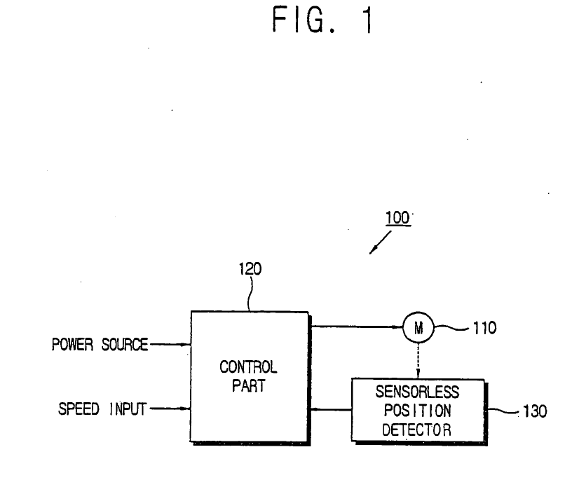

FIG. 1 is a block diagram of a BLDC motor control system 100 to which a method of controlling a speed of a BLDC motor according to an embodiment of the present invention is applied.

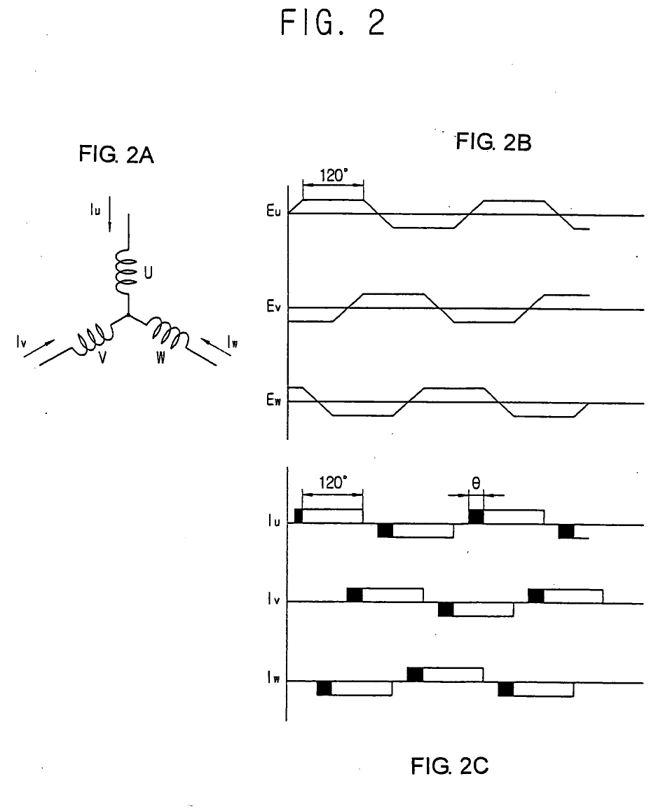

The control system 100 includes a BLDC motor 110 which is to be controlled, a control part 120 which receives power and a reference speed for motor control and controls the motor 110, and a sensorless position detector 130 by which the speed of the motor 110 is measured for feedback control of the motor 110. The control part 120 may further include a converter (not shown) to convert an alternating current (AC) into a direct current (DC) if the power is of alternating current. Also, the control part 120 may further include an inverter (not shown) to input a driving signal (i.e. a driving current) to the motor 110. The inverter may be used to input a periodic current signal, as shown in FIG. 2. The motor 110 may be, but is not limited to, a conventional three-phase brushless motor. As will be described later, the three-phase brushless motor has a reference current applying angle of 120°.

The sensorless position detector 130 is a device that detects the position of a rotator through, for example, filtering of a terminal voltage of the motor 110. The sensorless position detector 130 may be provided as, for example, a Hall device, a photo diode, a magnetoresistance element, etc.

FIG. 2 shows respective driving signals and waveforms of applied voltages when the control system 100 of FIG. 1 is applied to drive the motor 110.

The motor 110, as shown in FIG. 2A, sequentially inputs driving currents Iu, Iv and Iw to three electrode coils U, V and W, respectively, so that a rotator that includes a permanent magnet generator may be rotated. The driving currents are sequentially inputted to the motor 110 with corresponding waveforms as shown in FIG. 2C. That is, 360° are equally divided into three parts, and the driving current (i.e. the driving signal) Iu of the first 120° is applied to the coil U, the driving current Iv of the second 120° is applied to the coil V, and the driving current Iw of the last 120° is applied to the coil W. The motor 110 may be continuously driven to rotate by repeatedly applying the above driving currents. Therefore, the driving currents inputted to each of the coils have a reference current applying angle of 120°.

According to the input of the driving currents, the motor 110 generates induced voltages Eu, Ev and Ew, which have waveforms as shown in FIG. 2B. As the induced voltages are proportional to a rotating speed

of the motor 110, the rotating speed of the motor 110 may also be regarded as having graphs similar to those of the induced voltages.

According to the graphs of the induced voltages Eu, Ev and Ew, each induced voltage has a uniform output which corresponds to the input of each driving current. Therefore, the overall output of the motor 110 may be maintained to be uniform because of the induced voltages Eu, Ev and Ew which are successively generated one after another.

According to the above-mentioned driving method, the control part 120 receives an input reference speed and generates the driving currents (i.e. the driving signals) to rotate the motor 110.

Further, the BLDC motor control system 100 employs a method of increasing the current applying angles of the driving currents Iu, Iv and Iw if the rotating speed of the motor 110 does not reach the reference speed, even if the input values of the driving currents Iu, Iv and Iw have reached a maximum input of the motor 110.

That is, as shown in FIG. 2C, the start point to apply each driving current is advanced by a predetermined amount (angle θ) so that the total current applying angle may be 120°+θ. Accordingly, neighboring driving currents are generated overlappingly by θ°. Thus, the rotating speed of the motor 110 is increased as a consequence. For example, in a three-phase BLDC motor used for a conventional refrigerator, increasing the current applying angle to 150° leads to a speed increase of 400˜500 rpm compared with the rotating speed when the reference current applying angle of 120° is applied to the motor 110.

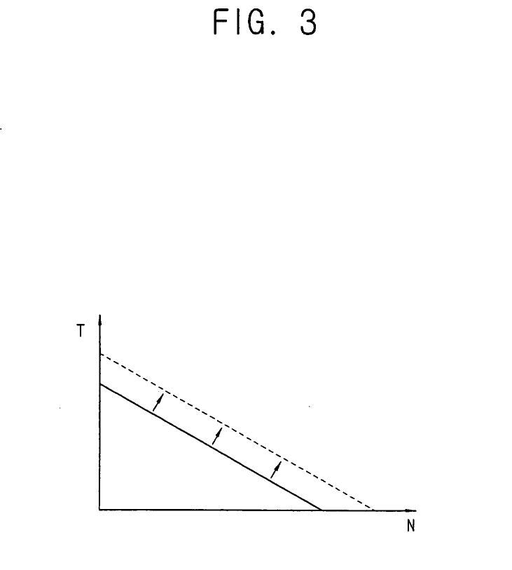

FIG. 3 is a graph that shows the speed increase effect described above. The solid line in the graph represents a relation between a rotating speed N and a torque T of the motor 110 when the current applying angle of 120° is applied to the motor 110. The dotted line in the graph represents a relation between the rotating speed N and the torque T of the motor 110 when the current applying angle is increased to, for example, 150°. Comparing the two lines, it can be seen that the motor 110 may have an improved capability when the current applying angle is increased.

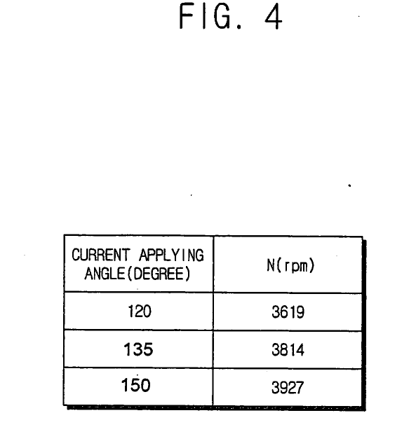

FIG. 4 is an exemplary table showing the rotating speed N of the motor 110, where the rotating speed N changes according to the increase of the current applying angle. The standard current applying angle, as shown in the first position in the table of FIG. 4, is 120°, and the output rotating speed N is measured as the current applying angle is increased by the increment angle of 15° to a current applying angle of 150°. As seen in the table, the output rotating speed N at the reference current applying angle of 120° is 3619 rpm. The output rotating speed N at the increased current applying angle of 135° (i.e. 120+15°) is increased to 3814 rpm, and the output rotating speed N at the increased current applying angle of 150 degrees (i.e. 120+30°) is increased to 3927 rpm. While the current applying angle in the table of FIG. 4 is incremented by 15 degrees, the increment angle may be greater than or less than 15°. According to experiment, the current applying angle is able to be increased to 150° for the sensorless driving type BLDC motor.

Therefore, the control part 120 may increase the rotating speed of the motor 110 by increasing the current applying angle of the driving current. Furthermore, using the feedback control of the rotating speed of the motor 110 through the sensorless position detector 130, the control part 120 may gradually increase the current applying angle of the driving signal by a predetermined increment until the rotating speed reaches the reference speed.

Similarly, using the feedback control of the rotating speed of the motor 110 through the sensorless position detector 130, the control part 120 may gradually decrease the increased current applying angle until the rotating speed of the motor 110 reaches the reference speed when the rotating speed of the motor 110 exceeds the reference speed because of the increased current applying angle.

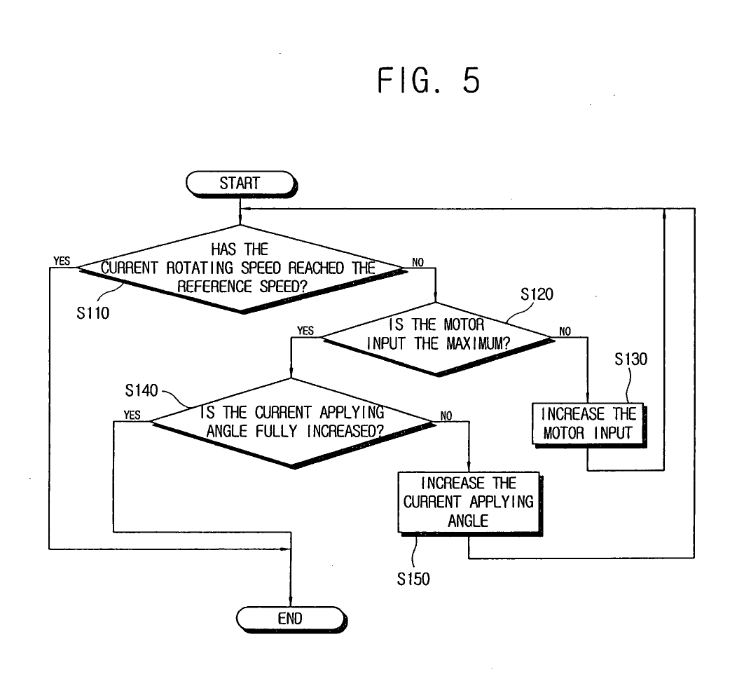

FIG. 5 is a flow diagram showing a process of controlling the rotating speed of the motor 110 at the control part 120. The control part 120, which has received the input reference speed, drives the motor 110, and determines through the sensorless position detector 130 whether or not the current rotating speed of the motor 110 has reached the reference speed at S110. If the rotating speed of the motor 110 has not reached the reference speed, the control part 120 determines whether the driving signals (i.e. the driving currents) inputted into the motor 110 have reached the maximum input that the motor 110 can accommodate at S120. If the driving signals have not reached the maximum input, the control part 120 gradually increases the driving signals to the maximum input of the motor 110 at S130.

If the rotating speed of the motor 110 does not reach the reference speed even after the driving signals have been increased to the maximum input of the motor 110, the control part 120 determines whether the current applying angle has been fully increased at S140. If the current applying angle has not been fully increased, the control part 120 increases and inputs the current applying angle into the motor 110 at S150. The manner in which the current applying angle is incremented and the use of feedback control during the increase of the current applying angle were previously discussed above.

The control of the motor speed shown in FIG. 5 may also be applied to a control of a cooling speed of a refrigerator in the same manner. That is, the control part 120 may calculate the reference speed to drive the motor 110 in order to achieve a predetermined reference temperature. Then, the control part 120 generates the driving signal from the calculated reference speed, and inputs the driving signal into the motor 110. The control part 120 controls the motor 110 by the control method shown in FIG. 5 to achieve the reference speed. The process shown in FIG. 5 to achieve the reference speed corresponds to the process to achieve the reference temperature for a cooling operation of the refrigerator. Therefore, by using the refrigerator which adopts the above control method, the reference temperature for the cooling operation of the refrigerator may be achieved within a shorter time.

Although an embodiment of the present invention has been shown and described, it will be appreciated by those skilled in the art that changes may be made in this embodiment without departing from the principles and spirit of the invention, the scope of which is defined in the appended claims and their equivalents.

For example, although the above embodiment describes the refrigerator which adopts the method of controlling the speed of a BLDC motor, the above method is not limited to the refrigerator but may also be applied to any other cooling or heating apparatus in the same or similar way. Furthermore, the above method may also be applied to all apparatuses that include a BLDC motor.

What is claimed is:

1. A method of controlling a speed of a BLDC motor, the method comprising:
inputting a driving signal having a current applying angle to the motor;
measuring a rotating speed of the motor;
determining whether the measured rotating speed has reached a reference speed;
increasing the current applying angle of the driving signal if determined that the measured rotating speed has not reached the reference speed and the driving signal has reached a maximum input of the motor; and
inputting the driving signal having the increased current applying angle to the BLDC motor.

2. The method of controlling the speed of a BLDC motor according to claim 1, wherein the increasing the current applying angle of the driving signal comprises gradually increasing the current applying angle of the driving signal by a predetermined angular increment until the rotating speed reaches the reference speed.

3. The method of controlling the speed of a BLDC motor according to claim 1, wherein the controlling the speed comprises controlling a three-phase brushless motor.

4. The method of controlling the speed of a BLDC motor according to claim 1, wherein the controlling the speed comprises controlling a three-phase brushless motor, and the inputting the driving signal comprises initially inputting a driving signal having acurrent applying angle of approximately 120 degrees and the increasing the current applying angle comprises increasing the current applying angle below approximately 150 degrees.

5. The method of controlling the speed of a BLDC motor according to claim 1, further comprising:
gradually decreasing the increased current applying angle of the driving signal until the rotating speed of the motor reaches the reference speed if the rotating speed of the motor exceeds the reference speed because of the increased current applying angle of the driving signal.

6. A method of controlling a cooling speed of a refrigerator which includes a compressor having a BLDC motor, the method comprising:
inputting a driving signal having a current applying angle to the motor;
measuring a cooling temperature of the refrigerator;
determining whether the measured cooling temperature has reached a reference temperature;
gradually increasing the current applying angle of the driving signal by a predetermined angular increment until the cooling temperature reaches the reference temperature if determined that the measured cooling temperature has not reached the reference temperature and the driving signal has reached a maximum input of the motor; and
inputting the driving signal having the increased current applying angle to the BLDC motor.

7. A brushless direct current motor control system, comprising:
a brushless direct current motor; and
a control part receiving a reference speed and inputting a driving signal to the motor;
wherein the control part increases a current applying angle of the inputted driving signal if a rotating speed detected by the brushless direct current motor control system is less than the reference speed.

8. The brushless direct current motor control system according to claim 7, further comprising a sensorless position detector detecting the rotating speed of the brushless direct current motor.

9. The brushless direct current motor control system according to claim 8, wherein the sensorless position detector is a Hall device.

10. The brushless direct current motor control system according to claim 8, wherein the sensorless position detector is a photo diode.

11. The brushless direct current motor control system according to claim 8, wherein the sensorless position detector is a magnetoresistance element.

12. The brushless direct current motor control system according to claim 7, wherein the control part decreases the increased current applying angle of the inputted driving signal if the rotating speed has exceeded the reference speed due to the increase of the current applying angle of the inputted driving signal.

13. The brushless direct current motor control system according to claim 7, wherein the control part increases the driving signal to a maximum input the motor can accommodate if the driving signal has not reached the maximum input of the motor before the current applying angle of the driving signal is increased.

14. A refrigerator, comprising:
a compressor having a brushless direct current motor; and
a control part receiving a reference speed to achieve a reference temperature and inputting a driving signal to the motor;
wherein the control part increases a current applying angle of the inputted driving signal if a detected cooling temperature of the refrigerator is less than the reference temperature.

15. The brushless direct current motor control system according to claim 14, wherein the control part decreases the increased current applying angle of the inputted driving signal if the cooling temperature has exceeded the reference temperature due to the increase of the current applying angle of the inputted driving signal.

16. The brushless direct current motor control system according to claim 14, wherein the control part increases the driving signal to a maximum input the motor can accommodate if the driving signal has not reached the maximum input of the motor before the current applying angle of the driving signal is increased.
